(19) United States
(12) Patent Application Publication
(10) Pub. No.: US 2014/0289805 A1
(43) Pub. Date: Sep. 25, 2014

(54) METHODS AND SYSTEMS FOR MANAGING USER PRIVILEGES

(71) Applicant: TENCENT TECHNOLOGY (SHENZHEN) COMPANY LIMITED, Shenzhen (CN)

(72) Inventors: ZHONGWEI LI, Shenzhen (CN); MING TIAN, Shenzhen (CN)

(73) Assignee: TENCENT TECHNOLOGY (SHENZHEN) COMPANY LIMITED, Shenzhen (CN)

(21) Appl. No.: 14/186,122

(22) Filed: Feb. 21, 2014

Related U.S. Application Data
(63) Continuation of application No. PCT/CN2013/086735, filed on Nov. 8, 2013.

(30) Foreign Application Priority Data
Mar. 20, 2013 (CN) 201310090257.6

(51) Int. Cl. H04L 29/06

(52) U.S. Cl. CPC H04L 63/08
USPC 726/4

(57) ABSTRACT

A method and system for managing user privileges are disclosed. The method includes the steps of receiving a first user's request to publish information and receiving groups of users defined by the first user, the groups of users having access to the to be published information. The method further includes the step of submitting the first user's request to a server, the request including an identity of the first user, information to be published, and the definition of the groups of users having access to the information. The method and system consistent with the present disclosure may improve the information dissemination process by enabling a user to proactively manage user privileges.

### CROSS-REFERENCES TO RELATED APPLICATIONS

### Related Applications

This application is a continuation application of PCT Patent Application No. PCT/CN2013/086735, filed on Nov. 8, 2013, which is based upon and claims the benefit of priority from Chinese Patent Application No. 201310090257.6, filed on Mar. 20, 2013, the entire contents of all of which are incorporated herein by reference.

### FIELD OF THE INVENTION

The present invention relates to computer technologies and, more particularly, to methods and systems for managing user privileges.

### BACKGROUND

With the development of Internet technologies, Internet communication services such as social networking, video sharing, and online chat rooms enable users to shift from an information downloading dominated form of participation to more active forms of participation that involves both downloading and uploading information. Users often upload user generated contents, such as personalized data, which provide enriched contents for communication services such as WeChat. By uploading user generated contents, however, the users may also expose themselves to an increased volume of advertisement. As such, one of the challenges faced by the online communication services is to properly control and manage the information dissemination process.

There are a few commonly used mechanisms to manage information dissemination. For example, an online communication service provider may filter information with keywords. A service provider may also manually review information before publishing. A service provider may further control user privileges, locking out users who have or have attempted to disseminate malicious information. These commonly used methods to manage information dissemination, however, are often inefficient and reactive to a user's past behavior. As a result, users of the online communication services may desire to proactively control how to disseminate information when uploading user generated contents.

The disclosed method and system are directed to solve one or more problems set forth above and other problems.

### BRIEF SUMMARY OF THE DISCLOSURE

Embodiments consistent with the present disclosure provide a method, system, terminal device, or a server for managing user privileges. Embodiments consistent with the present disclosure further improve the information dissemination process from a user to other users.

One aspect of the present disclosure provides a method for managing user privileges by a user terminal. The method includes the steps of receiving a first user's request to publish information and receiving groups of users defined by the first user, the groups of users having access to the to be published information. The method further includes the step of submitting the first user's request to a server, the request including an identity of the first user, information to be published, and the definition of the groups of users having access to the information.

Another aspect of the present disclosure provides a method for managing user privileges by a server. The method includes the steps of receiving a first user's request to publish information, the request including an identity of the first user, information to be published, and a definition of the groups of users having access to the information; and determining whether to publish the submitted information based on the request.

Another aspect of the present disclosure provides a system for managing user privileges. The system may include a user terminal and a server. The server further includes a receiving module configured to receive a first user's request to publish information, the request including an identity of the first user, information to be published, and a definition of the groups of users having access to the information; and a determination module configured to determine whether to publish the submitted information based on the request.

Embodiments consistent with the present disclosure enable a first user and/or a server to control the information dissemination to other users. The information may include broadcast messages and/or comments. The embodiments consistent with the present disclosure thus effectively disseminate the broadcast messages and/or comments to a second user and allow the first user and/or the server to proactively manage the information dissemination process. The embodiments consistent with the present disclosure improve the efficiency of the information dissemination process.

Other aspects of the present disclosure can be understood by those skilled in the art in light of the description, the claims, and the drawings of the present disclosure.

### BRIEF DESCRIPTION OF THE DRAWINGS

To illustrate embodiments of the invention, the following are a few drawings illustrating embodiments consistent with the present disclosure.

FIG. 1 is a flowchart of a method for managing user privileges implemented by an exemplary embodiment consistent with the present disclosure;

FIG. 2 is another flowchart of a method for managing user privileges implemented by an exemplary embodiment consistent with the present disclosure;

FIG. 3 is another flowchart of a method for managing user privileges implemented by an exemplary embodiment consistent with the present disclosure;

FIG. 4 is another flowchart of a method for managing user privileges implemented by an exemplary embodiment consistent with the present disclosure;

FIG. 5 is another flowchart of a method for managing user privileges implemented by an exemplary embodiment consistent with the present disclosure;

FIG. 6 is another flowchart of a method for managing user privileges implemented by an exemplary embodiment consistent with the present disclosure;

FIG. 7 is a schematic diagram of an exemplary apparatus for managing user privileges consistent with the present disclosure;

FIG. 8 is another schematic diagram of an exemplary apparatus for managing user privileges consistent with the present disclosure;

FIG. 9 illustrates an exemplary operating environment incorporating certain disclosed embodiments; and

FIG. 10 illustrates a block diagram of an exemplary computer system consistent with the disclosed embodiments.

### DETAILED DESCRIPTION

Reference will now be made in detail to exemplary embodiments of the invention, which are illustrated in the accompanying drawings. Hereinafter, embodiments consistent with the disclosure will be described with reference to drawings. Wherever possible, the same reference numbers will be used throughout the drawings to refer to the same or like parts. It is apparent that the described embodiments are some but not all of the embodiments of the present invention. Based on the disclosed embodiment, persons of ordinary skill in the art may derive other embodiments consistent with the present disclosure, all of which are within the scope of the present invention.

In the present disclosure, a user refers to a user of any network communication services, such as a communication service on the internet. An exemplary communication service may be WeChat. A user may publish information through a network communication service provider. The submitted information may be user generated contents, or any other contents. A user may publish the information so that only one or more defined groups of users can view, comment on, or forward his publications. The network service provider may implement a user privilege management system to manage different users' privileges to access different publications, thus improving the process of information dissemination. In the embodiments consistent with the present disclosure, user privilege refers to the right to access (including view, edit, forward, comment on, etc.) certain information. Publications may be any posting of articles, essays, photos, or other data submitted by a user to the communication service provider.

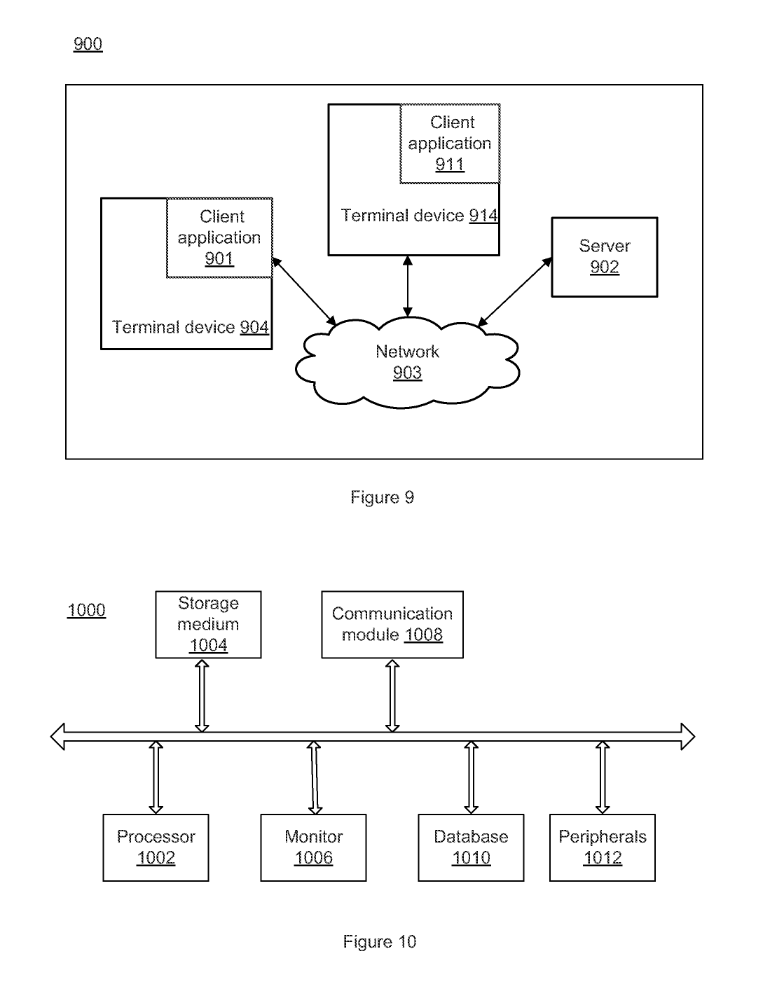

FIG. 9 illustrates an exemplary online computer environment 900 incorporating certain disclosed embodiments. As shown in FIG. 9, environment 900 may include terminal device 904, a network 903, and a server 902. The network 903 may include any appropriate type of communication network for providing network connections to the terminal devices 904 and 914, and the server 902. For example, network 903 may include the Internet, LAN (Local Area Network), or other types of computer networks or telecommunication networks, either wired or wireless.

A server, as used herein, may refer to one or more server computers configured to provide certain functionalities, which may require any user accessing the services to authenticate to the server before the access. A server may also include one or more processors to execute computer programs in parallel. The server 902 may include any appropriate server computers configured to provide certain server functionalities, such as storing information submitted by a user or information related to the user's privileges. Although only one server is shown, any number of servers can be included. The server 902 may operate in a cloud or non-cloud computing environment.

Terminal devices 904 and 914 may include any appropriate type of mobile computing devices, such as iOS devices (e.g., an iPhone or iPad) or devices using any other computing platforms. Terminal devices 904 and 914 may include one or more client applications 901 and 911. The client applications 901 and 911, as used herein, may include any appropriate software application, hardware application, or a combination thereof to achieve certain client functionalities. For example, client applications 901 and 911 may be an online communication application such as WeChat. Any number of client applications 901 and 911 may be included in the environment 900.

In one embodiment, the terminal device 904 may connect to a server 902 to upload or download data. A user may use client application 901 to upload or download data or disseminate information to other users. The terminal device 914, through application 911, may request viewing the data uploaded by the terminal device 904. The server 902 may determine whether the terminal device 914 can access the data uploaded by the terminal device 904.

Terminal devices 904/914 and server 902 may be implemented on any appropriate computing platform. FIG. 10 illustrates a block diagram of an exemplary computer system 1000 capable of implementing terminal devices 904/914 and server 902.

As shown in FIG. 10, computer system 1000 may include a processor 1002, storage medium 1004, a monitor 1006, a communication module 1006, a database 1010, and peripherals 1012. Certain devices may be omitted and other devices may be included.

Processor 1002 may include any appropriate processor or processors. Further, processor 1002 can include multiple cores for multi-thread or parallel processing. Storage medium 1004 may include memory modules, such as Read-only memory (ROM), Random Access Memory (RAM), flash memory modules, and erasable and rewritable memory, and mass storages, such as CD-ROM, U-disk, and hard disk, etc. Storage medium 1004 may store computer programs for implementing various processes, when executed by processor 1002.

Further, peripherals 1012 may include I/O devices such as keyboard and mouse, and communication module 1006 may include network devices for establishing connections through the communication network. Database 1010 may include one or more databases for storing certain data and for performing certain operations on the stored data, such as database searching.

In operation, the terminal device/client application 904/901 may submit or retrieve data from server 902. FIG. 1 shows a flow chart of a method for managing user privileges implemented by embodiments consistent with the present disclosure. As discussed in relation to FIGS. 9 and 10 above, a system for managing user privileges implementing such a method may include one or more terminal devices and one or more servers implementing user privilege managing functions. The terminal devices may also be referred to as user terminals. The method shown in FIG. 1 includes steps 101-103.

In step 101, a user of an online communication service (e.g., WeChat) may submit information to be published to the user terminal. The user terminal may receive the submission from the user. In step 102, the user may also define one or more groups of online friends (i.e., other users) that may be allowed to view the submitted information. The user terminal may receive the defined one or more groupings of friends. In step 103, the user, through the user terminal, may send a request to a server to publish the submitted information. The request may include the information defining the groups of friends that can view the submitted data. The request may also include the information to be published. The server may then use the received definition for the groupings of friends to manage the user privileges related to viewing the submitted information.

Embodiments consistent with the present disclosure enable a user to control the information dissemination process from the user's terminal. The embodiments consistent with the present disclosure thus effectively distribute the information and allow the user to proactively manage the information dissemination process. The embodiments consistent with the present disclosure improve the efficiency of the information dissemination process.

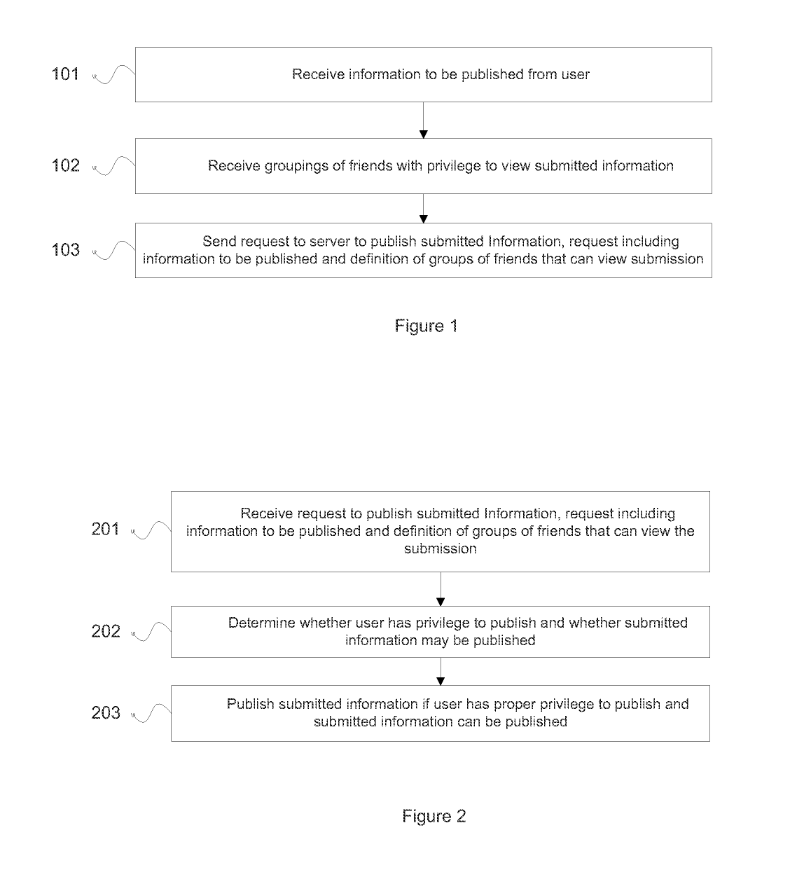

FIG. 2 shows a flow chart of a method for managing user privileges implemented by another embodiment consistent with the present disclosure. The method includes steps 201-203.

In step 201, the server may receive a request to publish the submitted information. The request may include the information defining the groups of friends that can view the submitted information. The request may also include the information to be published to the defined groups of friends.

In step 202, based on the received group definitions, the server may determine whether the user has the privilege to publish and whether the submitted information may be published. In step 203, if the user has the proper privilege to publish and the submitted information can be published, then server may publish the submitted information.

Embodiments consistent with the present disclosure enable a server to control the information dissemination process. The embodiments consistent with the present disclosure thus effectively disseminate the information and allow the server to proactively manage the information dissemination process. The embodiments consistent with the present disclosure improve the efficiency of the information dissemination process.

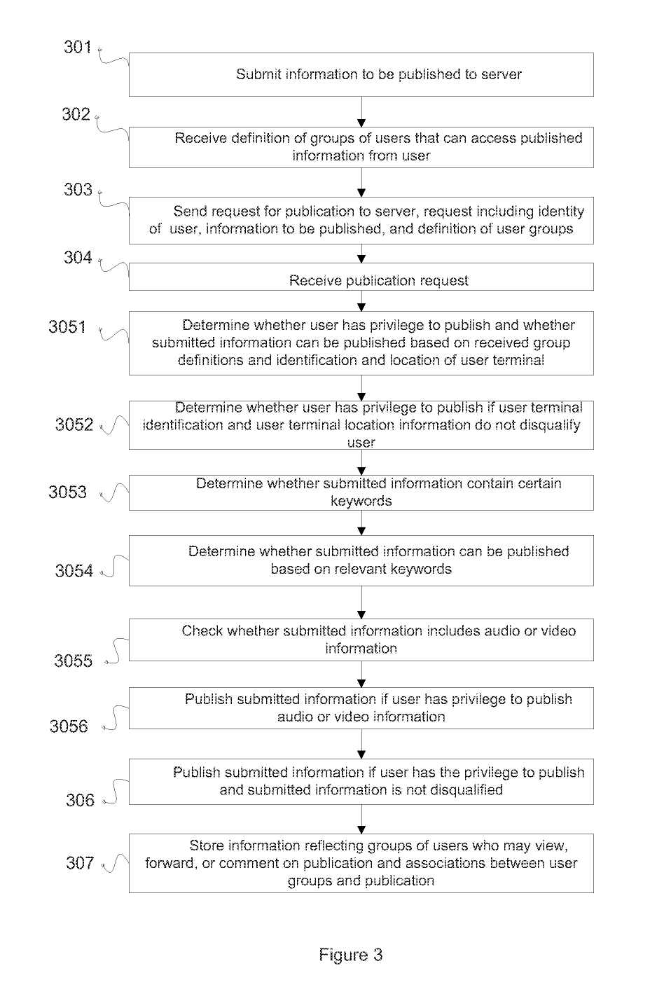

FIG. 3 shows a flow chart of a method for managing user privileges implemented by another embodiment consistent with the present disclosure. The method includes steps 301-307. The method shown in FIG. 3 is described below in relation to an exemplary user privilege management system in which a user submits information to be published by the system.

In step 301, user may submit information to be published to the server. The privilege management system may receive information from the user. The user may submit information defining which relevant users may have access to the submitted information. In step 302, the privilege management system may receive the definitions of groups of users from the user. The user may categorize his online friends (i.e., users) into different groups. For example, the user may group his personal friends into one group named “friends,” his classmates into another group named “classmates,” and his colleagues into another group named “colleagues.” The user may then submit the user groupings to the server. The server may label each user based on the groupings. For example, all users in the group for friends may be labeled “friends;” all users in the group for classmates may be labeled “classmates;” and all users in the group for colleagues may be labeled “colleagues.” Based on the labels assigned, each user may belong to one or more groups.

When the user is ready to publish certain information, he may select one or more groups of users to be the audience of the published information. For example, a user may decide that he wants to share a photo with the “friends” group, but not with the others. In the case that the user does not select the audience a publication, the user privilege management system may give access to all users/groups that have connected with the user who authored the information.

In addition, a user who is publishing the information may also select one or more groups of users to have the privilege to forward or comment on the publication. For example, a user may give viewing privilege to one publication to groups “friends” and “colleagues,” but only allow the users in the “friends” group to forward or comment on the publication.

Yet in other embodiments, a user who is publishing the information may use algorithms provided by the service provider to define one or more groups of users having privileges to access the published information. For example, the service provider may apply an algorithm to randomly select one or more users from the user's online friends to form a “random shaker” group. The user may assign access privileges (viewing, editing, etc.) to the users in the “random shaker” group. Other algorithms, such as selecting users based on certain traits or a combination of traits, can also be provided by the service provider. A trait of a user can be any characterizing data of the user, such as, gender, location, age, financial status, etc. The service provider may suggest groupings of users to the user based on applications of such algorithms.

In step 303, the user may send a request for publication to the server of the user privilege management system. The request may include the identification of the user who is the author of the proposed publication as well as the definition of groups of users who would have access to the publication. The server may therefore manage user privileges according to the definition of groups submitted by the user. In some embodiments, the user privilege management system may obtain the identification of the user terminal from which the publication is submitted. The user privilege management system may also obtain the location information of the user terminal that submitted the information to be published.

In step 304, the server may receive the request to publish the submitted information. The request may include the information defining the groups of friends that can view the submitted information. The request may also include the information to be published to the defined groups of friends.

In step 305 (not shown), based on the received group definitions and the identification and location of the user terminal, the server may determine whether the user has the privilege to publish and whether the submitted information can be published. When the user privilege management system receives the user terminal identification and the location information, the system may perform steps 3051-3056 to determine whether the user has the privilege to publish and whether the submitted information can be published.

In step 3051, based on the identity of the user (i.e., the author), the identification of the user terminal from which the publication is submitted, and the location of the user terminal, the privilege management system may determine whether the user (i.e., the author) has the authority to publish the submitted information.

For example, the user privilege management system may determine that certain users do not have the privilege to publish because these users have previously sent spams. In case a blacklisted user changes his identification, the user privilege management system may determine that a user using the same user terminal as the previously blacklisted user still does not have the privilege to publish. In addition, by using the user terminal location information, the user privilege management system may limit the locations from which users can publish certain information. The user privilege management system may therefore manage publications related to certain hot topics specific to a geographic region.

In step 3052, if the user terminal identification and user terminal location information do not disqualify the user (i.e. author) from publishing the information, the user privilege management system may determine that the user has the privilege to publish. The user privilege management system may then determine whether the submitted information can be published.

In step 3053, the user privilege management system may determine whether the submitted information contain certain keywords. In step 3054, the user privilege management system may determine that the submitted information can be published if it does not contain the relevant keywords. The user privilege management system may deny the request for publication if the submitted information contains those keywords.

In step 3055, if the submitted information does not contain any of the relevant keywords, the user privilege management system may check whether the submitted information includes audio or video information. If the submitted information includes audio or video information, the user privilege management system may check whether the user (i.e., the author) has to the privilege to publish audio or video information. If the user does not have the privilege to publish audio or video information, then the user privilege management system would not publish the submitted information. In step 3056, the user privilege management system may publish the submitted information if the user has the privilege to publish audio or video information.

In step 306, the user privilege management system may publish the submitted information if the user has the privilege to publish and the submitted information is not disqualified from being published. In step 307, the user privilege management system may store the information reflecting the groups of users who may view, forward, or comment on the publication. The user privilege management system may also store the proper associations between the user groups and the publication.

Embodiments consistent with the present disclosure enable a user and/or a server to control the information dissemination process. The embodiments consistent with the present disclosure thus effectively disseminate the information and allow the user and/or the server to proactively manage the information dissemination process. The embodiments consistent with the present disclosure thus improve the efficiency of the information dissemination process.

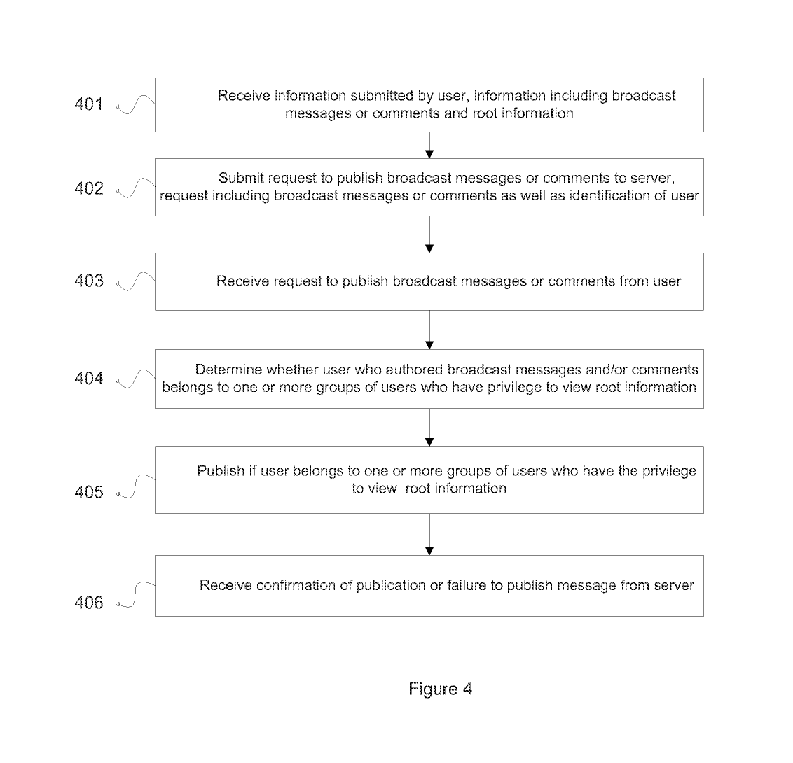

FIG. 4 shows a method for managing user privileges consistent with the present disclosure. The method shown in FIG. 4 is described below in relation to an exemplary user privilege management system in which a user submits information to be published. The method includes steps 401-406.

In step 401, the user privilege management system may receive information submitted by a user. The user may request that the submitted information be published. The submitted information may be broadcast messages or comments. The submitted information may include information identifying the root information on which the broadcast messages or the comments are based.

In step 402, the user may submit a request to publish the broadcast messages or the comments to the server of the user privilege management system. The user may include in the request the broadcast messages or the comments as well as the identification of the user (i.e., author). The server may determine whether the user who authored the broadcast messages and/or the comments belongs to one or more groups of users who have the privilege to view the root information. If the user belongs to one or more groups of users who have the privilege to view the root information, the user privilege management system may publish the submitted information. If not, the user privilege management system may send a message to the user denying the request to publish.

In step 403, the server may receive the request to publish the broadcast messages or the comments from the user. The user may include in the request the broadcast messages or the comments as well as the identification of the user (i.e., author). The received information may include information identifying the root information on which the broadcast messages or the comments are based.

In step 404, the server may determine whether the user who authored the broadcast messages and/or the comments belongs to one or more groups of users who have the privilege to view the root information. In step 405, if the user belongs to one or more groups of users who have the privilege to view the root information, the user privilege management system may publish the submitted information. The user privilege management system may further store the data reflecting the relationship between one or more user groups and the published information. After the submitted information is published, the user privilege management system may send a message to the user to confirm the publication. If the user does not belong to any group of users who have the privilege to view the root information, the user privilege management system may send a message to the user denying the request to publish. In step 406, the user terminal may receive a confirmation of publication or a failure to publish message from the server.

Embodiments consistent with the present disclosure enable a user and/or a server to control the information dissemination process. The information may include broadcast messages and/or comments. The embodiments consistent with the present disclosure thus effectively disseminate the broadcast messages and/or comments and allow the user and/or the server to proactively manage the information dissemination process. The embodiments consistent with the present disclosure thus improve the efficiency of the information dissemination process.

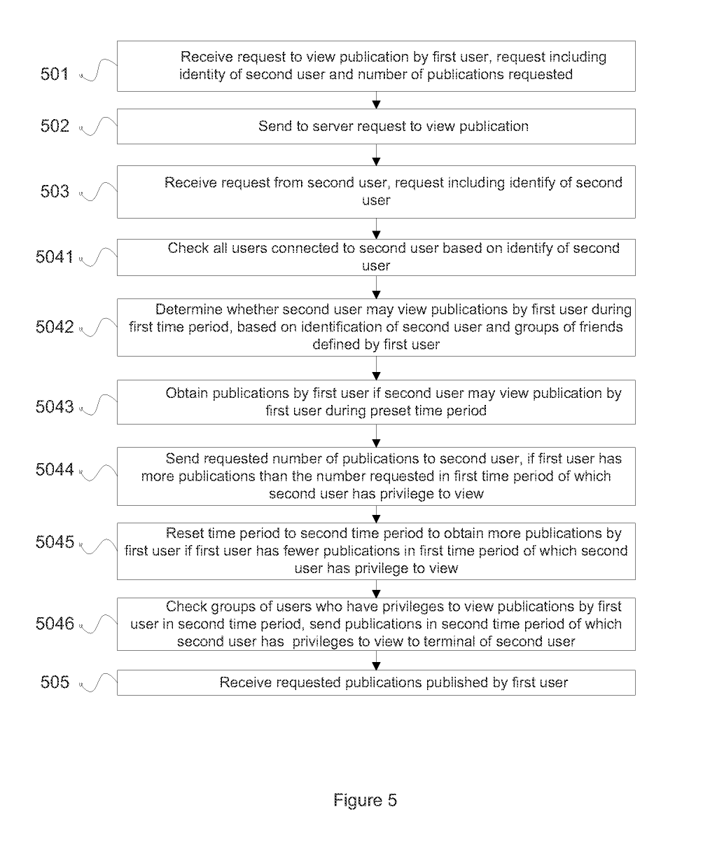

FIG. 5 shows a method for managing user privileges consistent with the present disclosure. The method shown in FIG. 5 is described below in relation to an exemplary user privilege management system in which a second user requests to view information published by a first user (i.e., the author). The method includes steps 501-505.

In step 501, the second user may request to view a publication by the first user. The second user may also include in the request the identification information of the second user. In one embodiment, the second user may include the number of publications by the first user of which he requests viewing.

In step 502, the second user terminal may send to the server of the user privilege management system the request t to view a publication. Based on the identity of the second user, the server may check all users connected to the second user. Based on the identification of the second user and the groups of friends defined by the first user, the user privilege management system may determine whether the second user may view the publication by the first user during a preset time period. If so, the user privilege management system may send the requested publication to the second user.

In step 503, the server may receive the request from the second user. The second user may include in the request the identity of himself and the number of publications by the first user of which he requests viewing. In step 504 (not shown), using the identification of the second user, the server may check all users connected to the second user. Based on the identification of the second user and the groups of friends defined by the first user, the user privilege management system may determine whether the second user may view the publication by the first user published during a preset time period. If so, the user privilege management system may send the requested publication to the second user.

In some embodiments, the second user may include the number of publications he wishes to view. The user privilege management system may then determine the number of publications to send to the second user, as described below in steps 5041-5045.

In step S041, the user privilege management system may obtain the information of the first user from the request submitted by the second user. In step S042, based on the identification of the second user and the groups of friends defined by the first user, the user privilege management system may determine whether the second user may view the publications by the first user during a preset first time period. In step S043, if the second user may view the publication by the first user during the preset time period, the user privilege management system may further obtain the publications by the first user. The user privilege management system may identify which publications by the first user can be viewed by the second user based on the results of step S042.

In step S044, if the first user has more publications than the number requested in the first time period of which the second user has privilege to view, the user privilege management system may send the requested number of publications to the second user. In this case, the user privilege management system may send the most recent qualified publications by the first user first. In step S045, if the first user has fewer publications in the first time period of which the second user has privilege to view, the user privilege management system may reset the time period to a second time period to obtain more publications by the first user. In step S046, the user privilege management system may check the groups of users who have privileges to view the publications by the first user in the second time period. The user privilege management system may send the publications in the second time period of which the second user has the privileges to view to the terminal of the second user. The user privilege management system may repeat steps 5045 and 5046 until the second user receives the requested number of publications by the first user.

In step 505, the terminal of the second user may receive the requested publications published by the first user.

Embodiments consistent with the present disclosure enable a first user and/or a server to control the information dissemination to other users. The information may include broadcast messages and/or comments. The embodiments consistent with the present disclosure thus effectively disseminate the broadcast messages and/or comments to a second user and allow the user and/or the server to proactively manage the information dissemination process. The embodiments consistent with the present disclosure improve the efficiency of the information dissemination process.

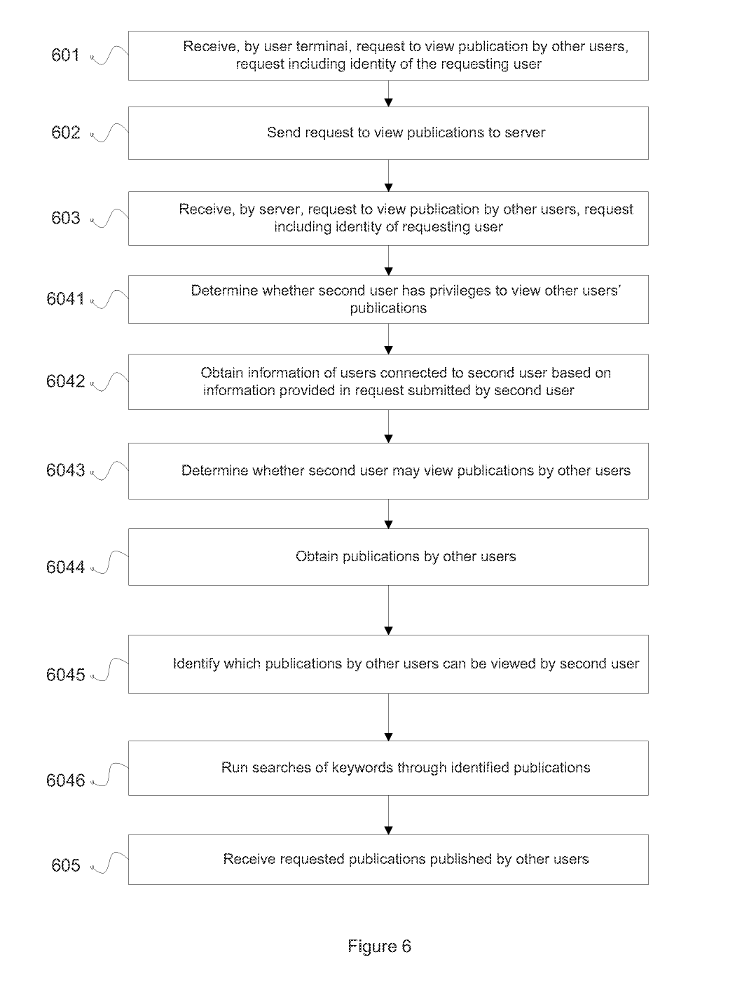

FIG. 6 shows a method for managing user privileges consistent with the present disclosure. The method shown in FIG. 6 is described below in relation to an exemplary user privilege management system in which a second user views information published by other users (i.e., the authors). The method includes steps 601-605.

In step 601, the second user may request to view a publication by other users. The second user may also include in the request the identification information of himself

In step 602, the second user terminal may send to the server of the user privilege management system the request to view publications. Based on the identity of the second user, the server may check all users connected to the second user. Based on the identification of the second user and the groups of friends defined by the other users (authors), the user privilege management system may determine whether the second user may view the publications by the other users during a preset time period. If so, the user privilege management system may send the requested publications to the second user.

In step 603, the server may receive the request from the second user. The second user may include in the request the identification of himself. In step 604 (not shown), using the identification of the second user, the server may check all users connected to the second user. Based on the identification of the second user and the groups of friends defined by the other users, the user privilege management system may determine whether the second user may view the publications by the other users during a preset time period. If so, the user privilege management system may send the requested publications to the second user. Step 604 is further described below in steps 6041-6046.

In step 6041, the user privilege management system may determine whether the second user has the privileges to view other users' publications. In step 6042, the user privilege management system may obtain the information of users connected to the second user based on the information provided in the request submitted by the second user. In step 6043, based on the identification of the other users and the groups of friends defined by the other users, the user privilege management system may determine whether the second user may view the publications by the other users during a first time period. In step 6044, if the second user may view the publication by the first user during a preset time period, the user privilege management system may further obtain the publications by the other users. In step 6045, the user privilege management system may identify which publications by the other users can be viewed by the second user. In step 6046, the user privilege management system may run searches of keywords through the publications identified in step 6045. For example, the user privilege management system may withhold publications containing certain keywords. The second user would not be able to view the withheld publications.

In step 605, the terminal of the second user may receive the requested publications published by the other users.

Embodiments consistent with the present disclosure enable a user and/or a server to control the information dissemination to a second user. The information may include broadcast messages and/or comments. The embodiments consistent with the present disclosure thus effectively disseminate the broadcast messages and/or comments to the second user and allow the first user and/or the server to proactively manage the information dissemination process. The embodiments consistent with the present disclosure improve the efficiency of the information dissemination process.

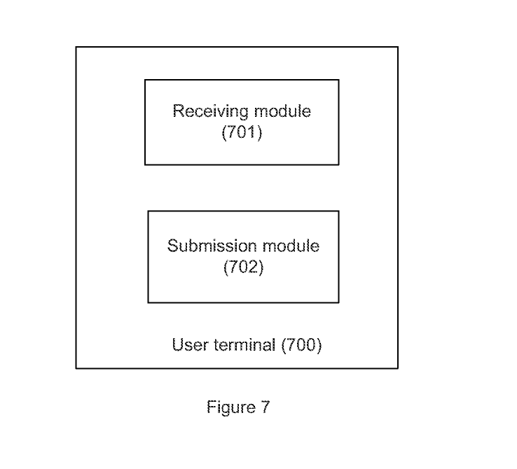

FIG. 7 shows a block diagram of an exemplary user terminal 700 in a user privileges management system consistent with the present disclosure. The user terminal 700 includes a receiving module 701 and a submission module 702.

The user privileges management system may use the receiving module 701 to receive the information that a first user plans to publish from the first user. The first user may also define certain groups of users with the privileges to view the published information. The user privileges management system may use the receiving module 701 to receive the user grouping information from the first user. The first user may further use the submission module 702 to send the request to publish to the server of the user privileges management system. The publishing request may include the identification of the first user and the information the first user wishes to publish. The user privilege manage system may then manage the user privileges based on the information received in the publication request.

In some embodiments consistent with the present disclosure, the user privilege management system may use the receiving module 701 to receive information submitted by a user. The user may request that the submitted information be published. The submitted information may be broadcast messages or comments. The submitted information may include information identifying the root information on which the broadcast messages or the comments are based.

The user terminal 700 may use the submission module 702 to submit a request to publish the broadcast messages or the comments to the server of the user privilege management system. The user may include in the request the broadcast messages or the comments as well as the identification of the user (i.e., author). The server may determine whether the user who authored the broadcast messages and/or the comments belongs to one or more groups of users who have the privilege to view the root information. If the user belongs to one or more groups of users who have the privilege to view the root information, the user privilege management system may publish the submitted information. If not, the user privilege management system may send a message to the user denying the request to publish.

After the submitted information is published, the user terminal 700 may use the receiving module 701 to receive a message from the server confirming the publication. If the user does not belong to any group of users who have the privilege to view the root information, the user terminal 700 may use the receiving module 701 to receive the message from the server denying the request to publish.

Embodiments consistent with the present disclosure enable a user and/or a server to control the information dissemination process. The information may include broadcast messages and/or comments. The embodiments consistent with the present disclosure thus effectively disseminate the broadcast messages and/or comments and allow the user and/or the server to proactively manage the information dissemination process. The embodiments consistent with the present disclosure improve the efficiency of the information dissemination process.

In other embodiments consistent with the present disclosure, the user may request to view a publication by other users. The user terminal 700 may use the receiving module 701 to receive a request to view other users' publications. The user may also include in the request the identification information of himself. The user terminal 700 may use the submission module 702 to send the request to the server of the user privilege management system.

Based on the identity of the second user, the server may check all users connected to the second user. Based on the identification of the second user and the groups of friends defined by the other users, the user privilege management system may determine whether the user may view the publications by the other users during a preset time period. If so, the user privilege management system may send the requested publications to the user. The user terminal 700 may use receiving module 701 to receive the requested publications by his friends.

The embodiments consistent with the present disclosure thus effectively disseminate the broadcast messages and/or comments authorized users and allow the user to proactively manage the information dissemination process through the user terminal. The embodiments consistent with the present disclosure improve the efficiency of the information dissemination process.

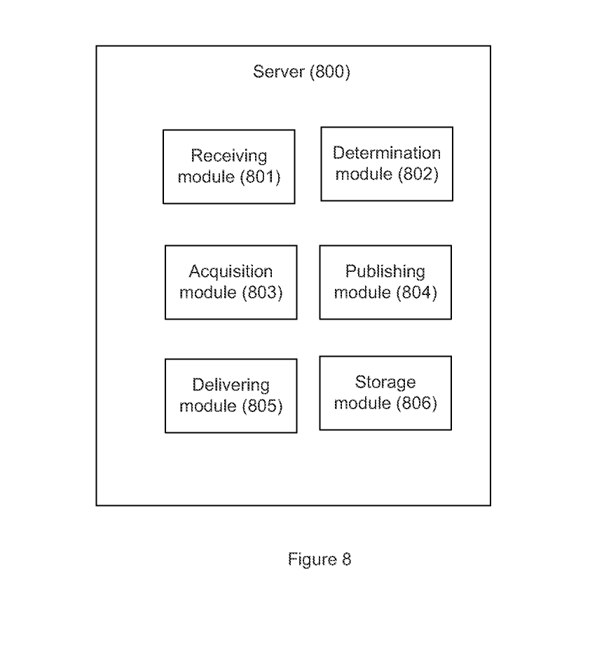

FIG. 8 shows a block diagram of an exemplary server 800 in a user privilege management system consistent with the present disclosure. The server 800 includes a receiving module 801, a determination module 802, an acquisition module 803, a publishing module 804, a delivering module 805, and a storage module 806.

The server 800 of the user privilege management system may use receiving module 801 to receive information from the user. The user may submit information to be published to the server. The server 800 may use receiving module 801 to receive the definitions of groups of users from the user. The user may submit information defining which relevant user may have the access to the submitted information. The server 800 may use the publishing module 804 to publish information if the user has the user privilege to publish and the submitted information does not contain certain keywords.

The server 800 may therefore manage user privileges according to the definition of groups submitted by the user. In some embodiments, the user privilege management system may use the acquisition module 803 to obtain the identification of the user terminal from which the publication is submitted. The user privilege management system may also use the acquisition module 803 to obtain the location information of the user terminal that submitted the information to be published.

Based on the received group definitions, the server 800 may use determination module 802 to determine whether the user has the privilege to publish and whether the submitted information can be published. Based on the identity of the user (i.e., the author), the identification of the user terminal from which the publication is submitted, and the location of the user terminal, the server 800 may use determination module 802 to determine whether the user (i.e., the author) has the authority to publish the submitted information.

If the user identification and user terminal location information does not disqualify the user (i.e. author) from publishing the submitted information, the server 800 may use determination module 802 to determine that the user has the privilege to publish.

The server 800 may then use determination module 802 to determine whether the submitted information can be published. The server 800 may use determination module 802 to determine whether the submitted information contains certain keywords. The server 800 may use determination module 802 to determine that the submitted information can be published if it does not contain the relevant keywords. The server 800 may use determination module 802 to denial the request for publication if the submitted information contains those keywords.

If the submitted information does not contain any of the relevant keywords, the server 800 may use determination module 802 to determine whether the submitted information includes audio or video information. If the submitted information includes audio or video information, the server 800 may use determination module 802 to determine whether the user (i.e., the author) has the privilege to publish audio or video information. If the user does not have the privilege to publish audio or video information, then the server 800 may use determination module 802 to determine not to publish the submitted information. The server 800 may use determination module 802 to determine to publish the submitted information if the user has the privilege to publish audio or video information. The server 800 may use publishing module 804 to publish the submitted information.

In some embodiments consistent with the present disclosure, a second user may request to view a publication by the first user. The second user may also include in the request the identification information of the second user. The second user may include the number of publications by the first user of which he requests viewing.

The server 800 may use receiving module 801 to receive the request from the second user to view a publication. Based on the identity of the second user, the server 800 may use determination module 802 to check all users connected to the second user. Based on the identification of the second user and the groups of friends defined by the first user, the server 800 may use determination module 802 to determine whether the second user may view the publication by the first user during a preset time period. If so, the server 800 may use delivering module 805 to send the requested publications to the second user.

In some embodiments, the second user may include the number of publications he wishes to view. The server 800 may then use determine module 802 to determine the number of publications to send to the second user.

The server 800 may use the acquisition module 803 to obtain the information of the first user from the request submitted by the second user. Based on the identification of the second user and the groups of friends defined by the first user, the server 800 may use the determination module 802 to determine whether the second user may view the publications by the first user during a first time period. If the second user may view the publication by the first user during the preset first time period, the server 800 may use the acquisition module 803 to further obtain the publication by the first user. The server 800 may use the determination module 802 to determine which publications by the first user can be viewed by the second user based on the results.

If the first user has more publications in the first time period of which the second user has privilege to view, the user privilege management system may use delivering module 805 to deliver the requested number of publications to the second user. If the first user has fewer publications in the first time period of which the second user has privilege to view, the server 800 may use the acquisition module 803 to reset the time period to a second time period to obtain more publications by the first user. The server 800 may then use delivering module 805 to deliver the publications in the second time period of which the second user has the privileges to view to the terminal of the second user.

In other embodiments consistent with the present disclosure, a second user may request to view a publication by other users. The second user may also include in the request the identification information of himself.

Using the identification of the second user, the server 800 may use determination module 802 to check all users connected to the second user. Based on the identification of the second user and the groups of friends defined by the other users, the user privilege management system may use determination module 802 to determine whether the second user may view the publications by the other users during a preset time period. If so, the server 800 may use delivering module 805 to deliver the requested publications to the second user. In addition, the server 800 may use determination module 802 to check whether certain keywords are included in the requested publications. If not, the server 800 may use delivering module 805 to deliver the requested publications to the second user.

In some embodiments consistent with the preset disclosure, the server 800 may use receiving module 801 to receive information submitted by a user. The user may request that the submitted information be published. The submitted information may be broadcast messages or comments. The submitted information may include information identifying the root information on which the broadcast messages or the comments are based.

The server 800 may use determination module 802 to determine whether the user who authored the broadcast messages and/or the comments belongs to one or more groups of users who have the privilege to view the root information. If the user belongs to one or more groups of users who have the privilege to view the root information, the server 800 may use the publishing module 804 to publish the submitted information. If not, the server 800 may use the delivering module 805 to send a message to the user denying the request to publish.

Finally, the server 800 may use the storage module 806 to store user identification information, the groupings of users with privileges to see various publications, and associations between a publication and individual users and the groups of users with various access privileges.

Embodiments consistent with the present disclosure enable a first user and/or a server to control the information dissemination to a second user. The information may include broadcast messages and/or comments. The embodiments consistent with the present disclosure thus effectively disseminate the broadcast messages and/or comments to the second user and allow the first user and/or the server to proactively manage the information dissemination process. The embodiments consistent with the present disclosure thus improve the efficiency of the information dissemination process.

Consistent with embodiments of the present disclosure, one or more non-transitory storage medium storing a computer program are provided to implement the system and method for managing user privileges. The one or more non-transitory storage medium may be installed in a computer or provided separately from a computer. A computer may read the computer program from the storage medium and execute the program to perform the methods consistent with embodiments of the present disclosure. The storage medium may be a magnetic storage medium, such as hard disk, floppy disk, or other magnetic disks, a tape, or a cassette tape. The storage medium may also be an optical storage medium, such as optical disk (for example, CD or DVD). The storage medium may further be semiconductor storage medium, such as DRAM, SRAM, EPROM, EEPROM, flash memory, or memory stick.

Other embodiments of the disclosure will be apparent to those skilled in the art from consideration of the specification and practice of the invention disclosed herein. It is intended that the specification and examples be considered as exemplary only, with a true scope and spirit of the invention being indicated by the claims.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purposes. Various alternations, modifications, or equivalents to the technical solutions of the disclosed embodiments can be obvious to those skilled in the art and can be included in this disclosure.

By using the disclosed methods and systems, various user privilege management systems may be implemented. For example, a first user may share a family video with a group of his friends. The first user may define a group of his online connections as “personal friends” and only give this group the privilege to view the video. The user privilege management system may receive the video from the first user, and publish the video to the users in the “personal friends” group. The user privilege management system may further inform the first user of the publication and inform the user in the “personal friends” group of the new posting. The user privilege management system may also store the definition of the “personal friends” group and its association with the video file in a database for future use. By properly defining the access to the publication, the user privilege management system manages the information dissemination process according to the requirements of the first user.

What is claimed is:

1. A method for managing user privileges by a user terminal, comprising:
receiving a first user's request to publish information;
receiving information reflecting groups of users having access to the to be published information; and
submitting the first user's request to a server, the request including an identity of the first user, the information to be published, and the definition of the groups of users having access to the information.

2. The method according to claim 1, the method further comprising:
receiving a broadcast message or a comment from the first user, the broadcast message and the comment being based on root information;
submitting a request to publish the broadcast message or the comment to the server, the request including the identity of the first user and the broadcast message or the comment to be published, wherein the server may determine whether to publish based on whether the first user has privilege to access the root information; and
receiving a message from the server indicating whether the broadcast message or the comment is published.

3. The method according to claim 1, the method further comprising:
receiving a request from a second user to view the information published by the first user;
submitting the request from the second user to the server wherein the server determines whether the second user has privilege to view the information published by the first user based on the definition of groups of users submitted by the first user; and
receiving the published information by the first user from the server.

4. The method according to claim 1, wherein the server receives the request to publish from the first user and determines whether to publish the information submitted by the first user based on whether the first user has privilege to publish and whether the submitted information can be published.

5. The method according to claim 4, wherein the server determines whether the first user can publish the submitted information based on an identity of a user terminal used by the first user.

6. The method according to claim 4, wherein the server determines whether it can publish the submitted information based on location information associated with a user terminal used by the first user.

7. The method according to claim 6, wherein the server determines whether it can publish the submitted information based on a keyword in the submitted information.

8. The method according to claim 6, wherein the server determines whether it can publish the submitted information based on whether the first user has privilege to publish audio or video information.

9. A method for managing user privileges by a server, comprising:
receiving a first user's request to publish information, the request including an identity of the first user, the information to be published, and a definition of the groups of users having access to the information; and
determining whether to publish the submitted information based on the request.

10. The method according to claim 9, the method further comprising:
receiving a broadcast message or a comment from the first user, the broadcast message and the comment being based on root information;
receiving a request to publish the broadcast message or the comment, the request including the identity of the first user and the broadcast message or the comment to be published; and
determining whether to publish the broadcast message or the comment based on whether the first user has privilege to access the root information.

11. The method according to claim 9, the method further comprising:
receiving a request from a second user to view the information published by the first user;
determining whether the second user has privilege to view the information published by the first user based on the definition of groups of users submitted by the first user; and
delivering the published information by the first user to the second user.

12. The method according to claim 9, the method further comprising:
determining whether to publish the information submitted by the first user based on whether the first user has privilege to publish and whether the submitted information can be published.

13. The method according to claim 12, the method further comprising:
determining whether the first user can publish the submitted information based on an identity of a user terminal used by the first user.

14. The method according to claim 12, the method further comprising:
determining whether it can publish the submitted information based on location information associated with a user terminal used by the first user.

15. The method according to claim 14, the method further comprising
determining whether the server can publish the submitted information based on a keyword in the submitted information.

16. The method according to claim 14, the method further comprising:
determining whether the server can publish the submitted information based on whether the first user has privilege to publish audio or video information.

17. A system for managing user privileges including a user terminal and a server, the system comprising:
a receiving module of the server configured to receive a first user's request to publish information, the request including an identity of the first user, information to be published, and definition of the groups of users having access to the information; and
a determination module of the server configured to determine whether to publish the submitted information based on the request.

18. The system according to claim 17, wherein the receiving module of the server is further configured to receive a broadcast message or a comment from the first user, the broadcast message and the comment being based on root information; and a request to publish the broadcast message or the comment, the request including the identity of the first user, the broadcast message or the comment to be published; and
wherein the determination module of the server is further configured to determine whether to publish the broadcast message or the comment.

19. The system according to claim 18, wherein the receiving module of the server is further configured to receive a request from a second user to view the information published by the first user; and wherein the determination module of the server is further configured to determine whether the second user has privilege to view the information published by the first user based on the definition of groups of users submitted by the first user; the system further comprising:
a delivering module of the server configured to deliver the published information by the first user to the second user.

20. The system according to claim 19, wherein the determination module of the server is further configured to determine whether to publish the information submitted by the first user based on whether the first user has privilege to publish and whether the submitted information can be published.

21. The system according to claim 20, wherein the determination module of the server is further configured to determine whether the first user can publish the submitted information based on an identity of a user terminal used by the first user.

22. The system according to claim 20, wherein the determination module of the server is further configured to determine whether it can publish the submitted information based on location information associated with a user terminal used by the first user.

23. The system according to claim 22, wherein the determination module of the server is further configured to determine whether the server can publish the submitted information based on a keyword in the submitted information.

24. The system according to claim 22, wherein the determination module of the server is further configured to determine whether the server can publish the submitted information based on whether the first user has privilege to publish audio or video information.

25. The method according to claim 1, wherein the first user defines the groups of users having access to the to be published information.
